(19) United States
(12) Patent Application Publication
(10) Pub. No.: US 2006/0056668 A1
(43) Pub. Date: Mar. 16, 2006

(54) Image processing apparatus and image processing method

(75) Inventor: Hiroshi Ozaki, Asaka-shi (JP)

Correspondence Address: BIRCH STEWART KOLASCH & BIRCH, PO BOX 747, FALLS CHURCH, VA, 22040-0747, US

(73) Assignee: Fuji Photo Film Co., Ltd.

(21) Appl. No.: 11/225,209

(22) Filed: Sep. 14, 2005

(30) Foreign Application Priority Data
Sep. 15, 2004 (JP) 2004-268594

(51) Int. Cl. G06K 9/00

(52) U.S. Cl. 382/118

(57) ABSTRACT

The present invention provides an image processing apparatus, comprising: a photographed image input section which inputs a plurality of photographed images having human faces, a detection section which detects the human faces from the photographed images, an extraction section which extracts face images from the photographed images, the face images being an image of the detected human face, a template image input section which inputs a template image having composite areas each of which is a blank area for placing the face images, and a compositing section which places the extracted face images in the composite areas of the template image and composites the template image with the face images placed in the composite areas.

### BACKGROUND OF THE INVENTION

1. Field of the Invention

The present invention relates to an image processing apparatus and an image processing method, and particularly relates to an apparatus and a method for extracting a face portion from a recorded image of a person and compositing the extracted face onto a predetermined position of a template image.

2. Related Art

Various techniques have been conventionally developed to easily composite a face image, which is an image of the face of a person, with a background image and a clothes image. For example, according to Japanese Patent Application Publication No. 10-222649, two points used as the reference of compositing are designated for a background image and a clothes image, and the hair area of a face image and an area inside the contour of the face are used for compositing. Two points are designated as the reference of the compositing of the face image. The two points designated as the reference of the compositing of the face image are arranged on a horizontal line passing through a chin. The midpoint of a line connecting the two points is positioned on the chin and the length of the line is equal to the width of the face. A portrait image is generated by mapping the areas for the compositing of the face image so as to superimpose the two points designated for a face image onto the two points designated for the background image and so on.

### SUMMARY OF THE INVENTION

In recent years, so-called “clipped” template images have been developed in which the face of a person is made blank as if the face was cut out, and a face image extracted from a photographed image of a plurality of persons is placed and composited into a blank part. When a template has more blank parts than persons recorded in the photographed images from which face images are extracted, some blank parts are not filled with the face images and thus degrade the appearance of a composite image. The present invention is devised in view of this problem and has an object to provide an image processing apparatus and method which can composite more face images into a “clipped” template image.

In order to solve the problem, an image processing apparatus of the present invention comprises a photographed image input section which inputs a plurality of photographed images having human faces, a detection section which detects the human faces from the photographed images, an extraction section which extracts face images from the photographed images, the face images being an image of the detected human face, a template image input section which inputs a template image having composite areas each of which is a blank area for placing the face images, and a compositing section which places the selected face images in the composite areas of the template image and composites the template image with the face images placed in the composite areas.

According to the present invention, the face images extracted from a plurality of photographed images can be placed and composited into the composite areas of the template, thereby obtaining a composite image with more face images.

The image processing apparatus may further comprise a photographed image selection section which receives a selection of a plurality of desired photographed images from the plurality of photographed images. The detection section may detect human faces from the selected photographed images.

In this case, human face images extracted from the plurality of photographed images having been arbitrarily selected by the user can be composited into the “clipped” template image, so that more human faces can be composited so as to suit the preferences of the user.

Further, in order to solve the problem, an image processing method of the present invention comprises the steps of: inputting a plurality of photographed images having human faces, detecting the human faces from the photographed images, extracting face images from the photographed images, the face images being an image of the detected human face, inputting a template image having composite areas each of which is a blank area for placing the face images, and placing the selected face images in the composite areas of the template image and compositing the template image with the face images placed in the composite areas.

The image processing method has the same operation/working effect as the image processing apparatus.

According to present invention, face images extracted from the plurality of photographed images can be placed and composited into the composite areas of the template, thereby obtaining a composite image with more face images.

### BRIEF DESCRIPTION OF THE DRAWINGS

FIG. 1 is a schematic functional block diagram of an image processing apparatus according to Embodiment 1;

FIG. 2 shows a template image;

FIG. 3 is a flowchart showing the flow of a compositing process;

FIGS. 4A to 4C show a plurality of photographed images;

FIG. 5 shows that face images are composited into the template image; and

FIG. 6 is a schematic functional block diagram of an image processing apparatus according to Embodiment 2.

### DETAILED DESCRIPTION OF THE PREFERRED EMBODIMENTS

The following will describe preferred embodiments of the present invention with reference to the accompanying drawings.

### Embodiment 1

[Schematic Configuration]

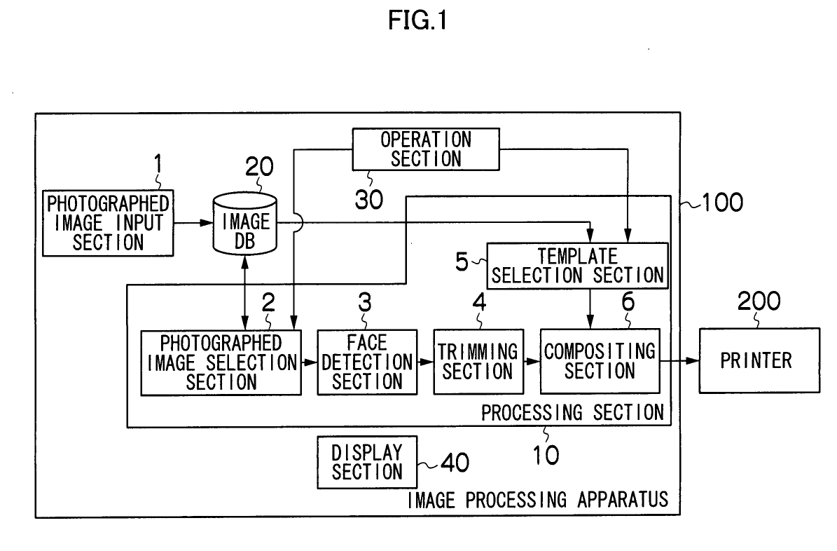

FIG. 1 is a schematic functional block diagram of an image processing apparatus 100 according to preferred Embodiment 1 of the present invention. The image processing apparatus 100 has a photographed image input section 1, a photographed image selection section 2, a face detection section 3, a trimming section 4, a template selection section 5, a compositing section 6, an image database (image DB) 20, an operation section 30, and a display section 40. The photographed image selection section 2, the face detection section 3, the trimming section 4, the template selection section 5, and the compositing section 6 are included in a processing section 10 constituted of a one-chip microcomputer.

The photographed image input section 1 inputs a plurality of photographed images which have been obtained from a digital still camera, a film scanner, a media driver, and various wireless/wired networks. The inputted plurality of photographed images are stored in the image DB 20.

The operation section 30 is constituted of a keyboard and a touch panel which receive an input from the user. The operation section 30 receives a selection of a desired photographed image from the plurality of photographed images having been stored in the image DB 20. The photographed image selection section 2 searches the image DB 20 for the photographed image having been selected by an operation of the operation section 30 and outputs the image to the face detection section 3.

The face detection section 3 detects a human face from the photographed image according to a known face recognition technique. When a plurality of persons are recorded in the photographed image, a plurality of faces are detected one by one. The trimming section 4 extracts the detected individual faces as separate images from the photographed image. The extracted images are called face images.

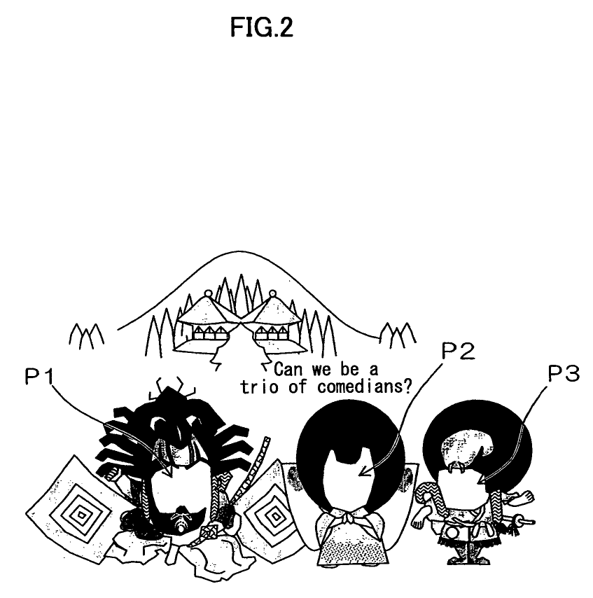

The image DB 20 stores template images beforehand. As shown in FIG. 2, the template image has a composite area Pn (n=1 to 3 in FIG. 2) which is a blank area for compositing a face image. The shapes and number of the composite areas and the pattern of the image are not limited to those of FIG. 2. The template selection section 5 receives, in response to an operation of the operation section 30, a selection of a desired template image from the template images stored in the image DB 20 and outputs the selected template image to the compositing section 6. The compositing section 6 creates a composite image in which the face images have been extracted by the trimming section 4 are placed and composited into the composite areas of the template image having been outputted by the template selection section 5.

The display section 40 is constituted of a liquid crystal display and the like to display a face image, a template image, a composite image, and so on. The image processing apparatus 100 may be connected to a printer 200 for printing a composite image. Further, the image processing apparatus 100 may have a media writer and the like (not shown) for storing composite images in a predetermined recording medium.

[Processing Flow]

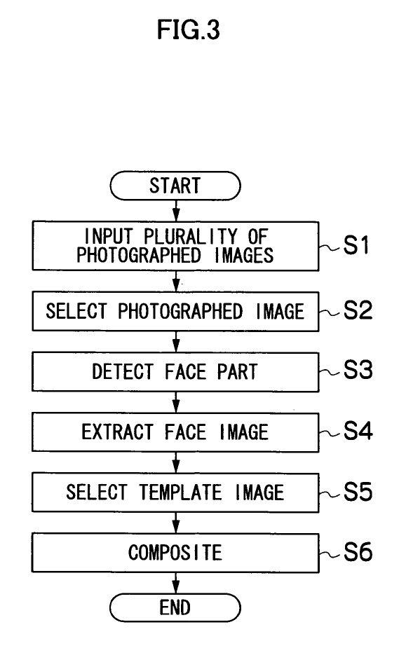

Referring to the flowchart of FIG. 3, the following will discuss the flow of a compositing process performed by the image processing apparatus 100.

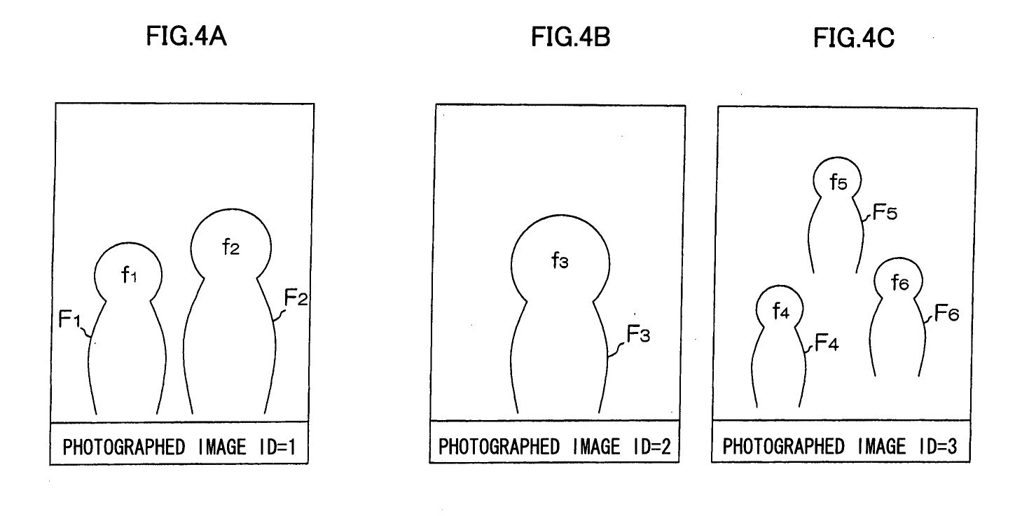

In S1, the photographed image input section 1 inputs a plurality of photographed images of persons, and the photographed image input section 1 stores the images in the image DB 20 in relation to unique identification numbers. FIG. 4 shows an example of the plurality of photographed images which are inputted from the photographed image input section 1 and stored in the image DB 20. Each of the photographed images is given a photographed image ID (in this case, photographed image ID=1 to 3) which is a unique identification number. In the photographed image of FIG. 4A, persons F1 and F2 are recorded. In the photographed image of FIG. 4B, only a person F3 is recorded. In the photographed image of FIG. 4C, persons F4 to F6 are recorded. The way to record the plurality of photographed images to be inputted is not particularly limited. The images may be taken by different cameras, serially taken by a single camera, taken by a plurality of cameras at different angles, or taken at different times and places.

In S2, the photographed image selection section 2 enables a selection of a plurality of desired photographed images to be composited with a template image from the photographed images having been stored in the image DB 20. In FIG. 4, the display section 40 indicates that the photographed images with ID=1 and 2 are selected. The photographed image selection section 2 searches the image DB 20 for the plurality of selected photographed images and outputs the images to the face detection section 3.

In S3, the face detection section 3 detects a face of the person Fn from each of the photographed images having been outputted from the photographed image selection section 2. For example, in the photographed image ID=1 shown in FIG. 4A, a face f1 of the person F1 and a face f2 of the person F2 are detected. In the photographed image ID=2 shown in FIG. 4B, a face f3 of the person F3 is detected.

In S4, the trimming section 4 extracts a face image, which is an image of the detected face of the person Fn, from the photographed images. Hereinafter, face images corresponding to the faces will be also designated as f1, f2, and f3 just like the faces.

In S5, the template selection section 5 enables a selection of a desired template image to be composited with the face images from template images having been stored in the image DB 20. The template selection section 5 searches the image DB 20 for the selected template image and outputs the image to the compositing section 6. For simple explanation, the following will discuss the case where the template image of FIG. 2 is selected.

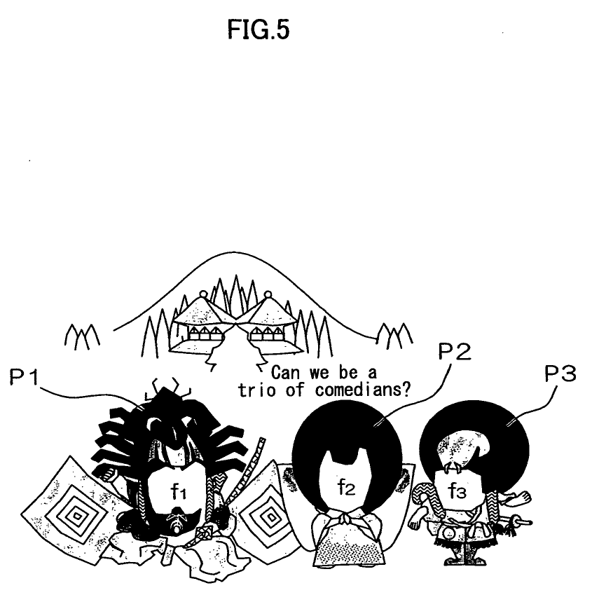

In S6, the compositing section 6 places the extracted face image fn into the composite area Pn of the template image having been outputted from the template selection section 5, and then composites the face image fn and the template image. The compositing section 6 may composite the images after properly performing image processing such as scaling, aspect ratio change, centering, and color change on the face image fn so as to suitably composite the face image fn into the composite area Pn. FIG. 5 shows that the face images and the template image are composited together.

As described above, the photographed image selection section 2 searches the image DB 20 for the plurality of selected photographed images and outputs the images to the compositing section 6. The trimming section 4 extracts the face images from the plurality of selected photographed images. The compositing section 6 places and composites the face images into the composite areas of the template. That is, the user arbitrarily selects the plurality of photographed images, so that the face images extracted from the photographed images can be composited into the “clipped” template, thereby achieving a composite image with a number of face images.

### Embodiment 2

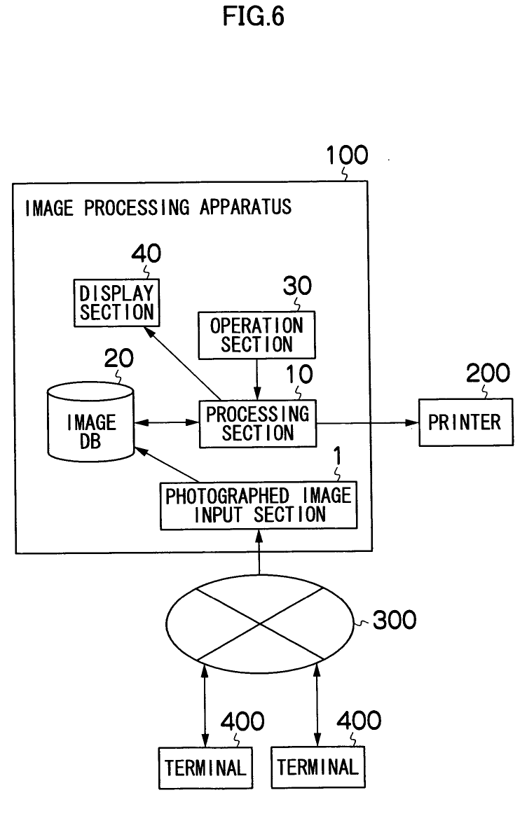

As described above, a photographed image input section 1 of an image processing apparatus 100 may input a photographed image through a network. For example, as shown in FIG. 6, the photographed image input section 1 is connected to a network 300 such as the Internet and receives inputs (uploads) of photographed images from terminals 400 such as personal computers connected to the network 300. A processing section 10 of FIG. 6 is similar in configuration to Embodiment 1 and thus the detailed explanation thereof is omitted. The photographed images uploaded from the terminals 400 are stored in an image DB 20 in relation to unique identification numbers. Also regarding the photographed images stored in the image DB 20, the above compositing process makes it possible to extract face images from the photographed images having been uploaded from the terminals 400 possessed by the users and composite the extracted images into a “clipped” template image, thereby obtaining a composite image with many face images extracted from a number of images photographed by a number of photographers.

What is claimed is:

1. An image processing apparatus, comprising:
a photographed image input section which inputs a plurality of photographed images having human faces;
a detection section which detects the human faces from the photographed images;
an extraction section which extracts face images from the photographed images, the face images being an image of the detected human face;
a template image input section which inputs a template image having composite areas each of which is a blank area for placing the face images; and
a compositing section which places the extracted face images in the composite areas of the template image and composites the template image with the face images placed in the composite areas.

2. The image processing apparatus according to claim 1, further comprising a photographed image selection section which receives a selection of a plurality of desired photographed images from the plurality of photographed images,
wherein the detection section detects human faces from the selected photographed images.

3. An image processing method, comprising the steps of:
inputting a plurality of photographed images having human faces;
detecting the human faces from the photographed images;
extracting face images from the photographed images, the face images being an image of the detected human face;
inputting a template image having composite areas each of which is a blank area for placing the face images; and
placing the extracted face images in the composite areas of the template image and compositing the template image with the face images placed in the composite areas.
